(19) United States
(12) Patent Application Publication
(10) Pub. No.: US 2025/0364187 A1
(43) Pub. Date: Nov. 27, 2025

(54) VARIABLE CAPACITOR

(71) Applicants: DENSO CORPORATION, Kariya-city (JP); NATIONAL UNIVERSITY CORPORATION KOBE UNIVERSITY, Kobe-shi (JP)

(72) Inventors: Takuya KIGUCHI, Kariya-city (JP); Masaya TAKAHASHI, Kariya-city (JP); Nobuhisa YAMAGUCHI, Kariya-city (JP); Keisuke TANI, Kariya-city (JP); Yasuyuki HIKITA, Kariya-city (JP); Kenji ISHIDA, Kobe-shi (JP); Shohei HORIKE, Kobe-shi (JP); Yasuko KOSHIBA, Kobe-shi (JP)

(73) Assignees: DENSO CORPORATION, Kariya-city (JP); NATIONAL UNIVERSITY CORPORATION KOBE UNIVERSITY, Kobe-shi (JP)

(21) Appl. No.: 19/289,352

(22) Filed: Aug. 4, 2025

Related U.S. Application Data
(63) Continuation-in-part of application No. PCT/JP2024/002141, filed on Jan. 25, 2024.

(30) Foreign Application Priority Data
Feb. 2, 2023 (JP) 2023-014375

(51) Int. Cl. H01G 7/06

(52) U.S. Cl. CPC H01G 7/06

(57) ABSTRACT

In a variable capacitor, a first electrode layer is provided and an insulation layer is disposed on the first electrode layer. At least one second electrode layer section is arranged in at least one first region that is defined on the insulation layer. At least one third electrode layer section is arranged in at least one second region that is defined on the insulation layer. The at least one second region is disposed apart from the at least one first region. A dielectric layer is at least partially arranged in at least one third region disposed on the insulation layer and interposed between the at least one first region and the at least one second region. A fourth electrode layer is disposed on the dielectric layer.

### CROSS-REFERENCE TO RELATED APPLICATION

This application is a bypass continuation-in-part application of currently pending international application No. PCT/JP2024/002141 filed on Jan. 25, 2024 designating the United States of America, the entire disclosure of which is incorporated herein by reference, the international application being based on and claiming the benefit of priority from Japanese Patent Application No. 2023-014375 filed on Feb. 2, 2023, the disclosure of which is incorporated in its entirety herein by reference.

### TECHNICAL FIELD

The present disclosure relates to variable capacitors.

### BACKGROUND

One of known capacitors, which is disclosed in Japanese Patent Application Publication No. 2006-344845, includes a pair of electrodes, i.e., a ground electrode and a direct-current (DC) bias electrode, across which a DC bias is to be applied.

The capacitor disclosed in the patent publication includes dielectric layers arranged between the ground electrode and the DC bias electrode and includes a capacitance extraction electrode interposed between the dielectric layers.

The capacitor is configured to have a variable capacitance based on dielectric characteristics of the dielectric layers that vary depending on the DC bias applied across the ground electrode and the DC bias electrode.

### SUMMARY

The capacitor disclosed in the patent publication is configured such that the ground electrode, the capacitance extraction electrode, and the DC bias electrode are stacked in a predetermined direction through the dielectric layers. This configuration of the capacitor may have difficulty in setting one of (i) a distance between the ground electrode and DC bias electrode and (ii) a distance between the ground electrode and the capacitance extraction electrode independently from the other thereof.

The present disclosure can be implemented by an exemplary aspect described hereinafter.

The exemplary aspect of the present disclosure provides a variable capacitor. The variable capacitor includes a first electrode layer, an insulation layer disposed on the first electrode layer, and at least one second electrode layer section arranged in at least one first region that is defined on the insulation layer. The variable capacitor includes at least one third electrode layer section arranged in at least one second region that is defined on the insulation layer. The at least one second region is disposed apart from the at least one first region. The variable capacitor includes a dielectric layer at least partially arranged in at least one third region disposed on the insulation layer and interposed between the at least one first region and the at least one second region. The variable capacitor includes a fourth electrode layer disposed on the dielectric layer.

The variable capacitor of the exemplary aspect is configured such that a direction of a first electric field applied to the dielectric layer based on application of a DC voltage across the at least one second electrode layer section and the at least one third electrode layer section is different from that of a second electric field applied to the dielectric layer based on application of an AC voltage across the first and fourth electrode layers. This enables a distance between the first and fourth electrode layers to be set independently from a distance between the at least one second electrode layer section and the at least one third electrode layer section. The at least one second electrode layer section and the at least one third electrode layer section, which have a shorter distance therebetween, therefore enables the magnitude of an electric field applied to the dielectric layer to be greater, resulting in the DC voltage being lower. The insulation layer is arranged between the first electrode layer and the at least one third electrode layer section to thereby reliably isolate the first electrode layer from the at least one third electrode layer section.

For example, the insulation layer includes an oxide film that has resistance to chemicals used in the process of forming the upper layers of the insulation layer, making it possible to improve the manufacturability of the variable capacitor.

As another example, using a general-purpose high dielectric film as the insulation layer enables the variable capacitor to have a higher manufacturability.

### BRIEF DESCRIPTION OF THE DRAWINGS

Other aspects of the present disclosure will become apparent from the following description of an embodiment with reference to the accompanying drawings in which:

FIG. 1 is a perspective view of a variable capacitor;

FIG. 2 is a cross-sectional view taken along line II-II of FIG. 1;

FIG. 3 is a plan view of the variable capacitor;

FIG. 4 is an explanation view explaining PVDF (polyvinylidene fluoride);

FIG. 5 is a graph illustrating a relationship between (i) a control electric field and (ii) a relative permittivity;

FIG. 6 is a view explaining a relationship between the thickness of a dielectric layer and an electric-field distribution;

FIG. 7 is a graph illustrating a relationship between the thickness of the dielectric layer and the rate of change in the relative permittivity;

FIG. 8 is a view explaining a relationship between the thickness of each control-electrode layer section and an electric-field distribution;

FIG. 9 is a graph illustrating a relationship between the thickness of each control-electrode layer section and the rate of capacitance variability of the variable capacitor;

FIG. 10 is a view explaining a relationship among (i) control voltages, (ii) extraction voltages, and (iii) electric-field distributions; and

FIG. 11 is a graph illustrating how the rate of capacitance variability of the variable capacitor is changed depending on each of predetermined cases between the control voltages and the extraction voltages.

### DETAILED DESCRIPTION OF EMBODIMENT

### Exemplary Embodiment

The following describes a variable capacitor 1 according to an exemplary aspect of the present disclosure.

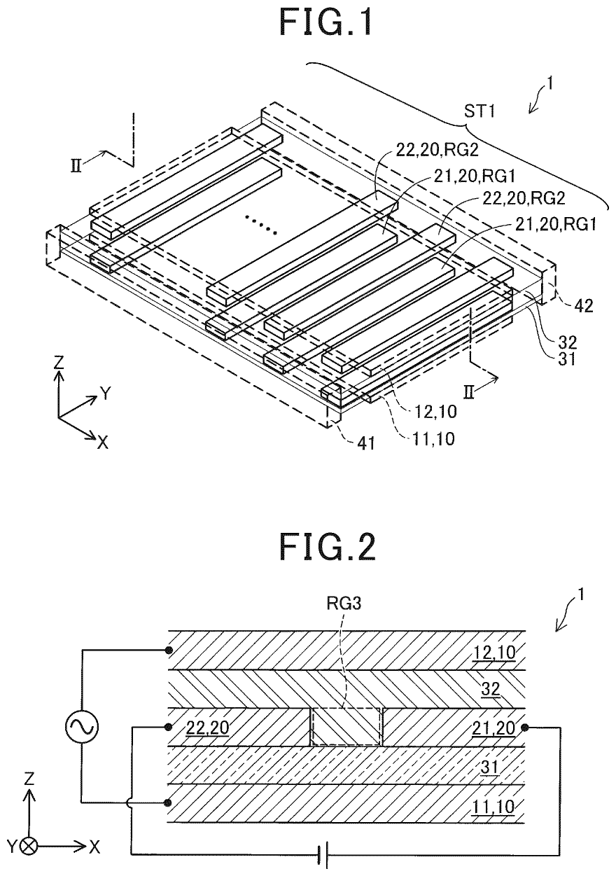

The variable capacitor 1 includes, as illustrated in FIG. 1, a first extraction-electrode layer 11 serving as a first electrode layer, a second extraction-electrode layer 12 serving as a fourth electrode layer, a plurality of first control-electrode layer sections 21 serving as a second electrode layer, a plurality of second control-electrode layer sections 22 serving as a third electrode layer, an insulation layer 31, a dielectric layer 32, a first extraction-electrode common layer 41, and a second extraction-electrode common layer 42. Each of the first and second extraction-electrode layers 11 and 12 will be also collectively referred to as an extraction-electrode layer 10. Each of the first and second control-electrode layer sections 21 and 22 will be collectively referred to as a control-electrode layer section 20.

FIG. 1 illustrates three spatial axes, i.e., X, Y, and Z axes, which are orthogonal to one another. The direction indicated by the arrow of each of the X, Y, and Z axes shows a positive direction in the corresponding one of the X, Y, and Z axes. The positive direction of the X axis will also be referred to as a positive X direction, the positive direction of the Y axis will also be referred to as a positive Y direction, and the positive direction of the Z axis will also be referred to as a positive Z direction.

The opposite direction of the direction indicated by the arrow of each of the X, Y, and Z axes shows a negative direction in the corresponding one of the X, Y, and Z axes. The negative direction of the X axis will also be referred to as a negative X direction, the negative direction of the Y axis will also be referred to as a negative Y direction, and the negative direction of the Z axis will also be referred to as a negative Z direction. The directions along the X-axis, Y-axis, and Z-axis, regardless of positive or negative orientation, will be referred to as the X direction, Y direction, and Z direction, respectively. The same convention applies to the drawings and descriptions presented hereinafter.

The first and second control-electrode layer sections 21 and 22 are arranged across which, as illustrated in FIG. 2, a control voltage is to be applied for adjusting a capacitance of the variable capacitor 1. The first and second extraction-electrode layers 11 and 12 serves as electrode layers for usage of the capacitance of the variable capacitor 1. Typically, the variable capacitor 1 is used in a state where a direct-current (DC) voltage as the control voltage is applied across the first and second control-electrode layer sections 21 and 22 and alternating current (AC) power is applied across the first and second extraction-electrode layers 11 and 12.

Each of the first and second extraction-electrode layers 11 and 12 according to the exemplary embodiment is made of gold (Au).

The variable capacitor 1 may be used in a state where an AC voltage is applied across the first and second control-electrode layer sections 21 and 22, and a DC voltage is applied across the first and second extraction-electrode layers 11 and 12.

The variable capacitor 1 has a multilayer structure.

The insulation layer 31 is, as illustrated in FIG. 2, mounted on the first extraction-electrode layer 11. The first and second control-electrode layer sections 21 and 22 are mounted on the insulation layer 31. This laminated configuration enables the first extraction-electrode layer 11 being electrically insulated from each of the first and second control-electrode layer sections 21 and 22.

The first control-electrode layer sections 21 are, as illustrated in FIG. 1, respectively disposed on a plurality of first regions RG1 defined over, i.e., on and above, the insulation layer 31, and the second control-electrode layer sections 22 are disposed on a plurality of second regions RG2 defined on and above the insulation layer 31. The first and second regions RG1 and RG2 are disposed apart from each other with third regions RG3 interposed.

The dielectric layer 32 is, as illustrated in FIG. 2, located to cover the first and second electrode layer sections 21 and 22, and extends to be disposed in the third regions RG3 of the insulation layer 31. Each pair of the first and second regions RG1 and RG2 is separated by a respective RG3 region. The second extraction-electrode layer 12 is disposed on and under the dielectric layer 32.

The in-plane direction of each layer or layer section refers to an X-Y direction along the plane of the corresponding layer or layer structure. The layers 10, 31, 20, 32, and 10 are stacked in a stacking direction that corresponds to the Z direction.

Each of the first and second electrode-layer sections 21 and 22 has, as illustrated in FIG. 1, a plate-like shape elongated along the Y direction. The first control-electrode layer sections 21 and the second control-electrode layer sections 22 are arranged alternately with a gap between each adjacent the sections 21 and 22.

Each first control-electrode layer section 21 has opposite ends in the Y direction. The end of each first control-electrode layer section 21 in the negative Y direction is electrically connected to the first extraction-electrode common layer 41. Each second control-electrode layer section 22 has opposite ends in the Y direction. The end of each second control-electrode layer section 22 in the positive Y direction is electrically connected to the second extraction-electrode common layer 42.

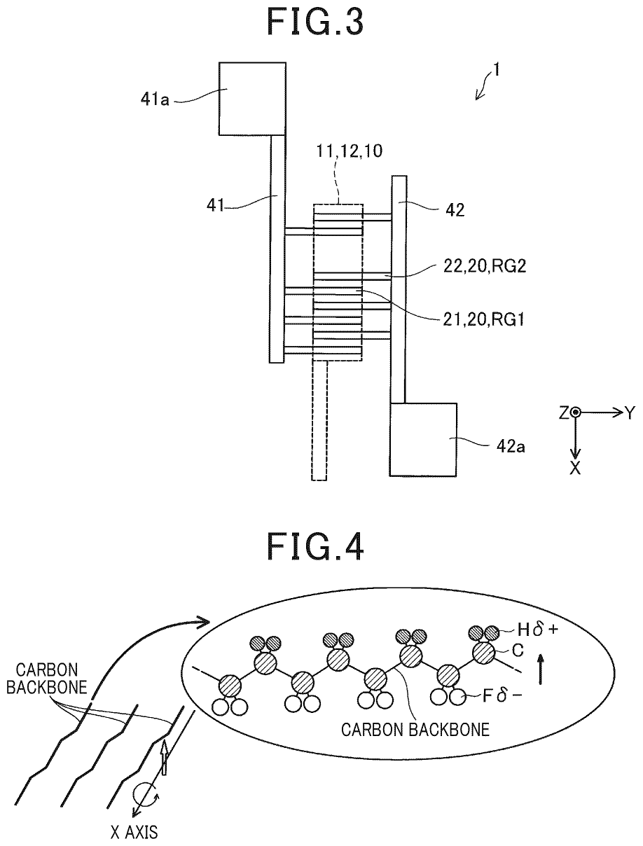

The variable capacitor 1 includes, as illustrated in FIG. 3, a first extraction-electrode common terminal 41a and a second extraction-electrode common terminal 42a. The first extraction-electrode common terminal 41a is electrically connected to the first extraction-electrode common layer 41. The second extraction-electrode common terminal 21a is electrically connected to the second extraction-electrode common layer 42.

The first control-electrode layer sections 21, which have a comb-like shape, and the second control-electrode layer sections 22, which have a comb-like shape, are interdigitated.

Specifically, the end of each first control-electrode layer section 21 in the negative Y direction is electrically connected to the first extraction-electrode common layer 41, and the end of each second control-electrode layer section 22 in the positive Y direction is electrically connected to the second extraction-electrode common layer 42. The first and second control-electrode layer sections 21 and 22 are alternately arranged.

As illustrated in FIG. 1, the first control-electrode layer sections 21 and the second control-electrode sections 22 are alternately arranged in the X direction with spaces therebetween, and the dielectric layer 32 is mounted over the layer sections 21 and 22 such that portions of the dielectric layer 32 extend into the spaces of adjacent layer sections 21 and 22.

In the above stacked structure, each first assembly ST1 of a first control-electrode layer section 21, a second electrode layer 22, and a portion of the dielectric layer 32 interposed them, such as 21-32-22 or 22-32-21, constitutes a capacitor. The capacitors of the first assemblies ST1 are connected in parallel to each other, resulting in the capacitance of the variable capacitor 1 being higher.

As illustrated in FIG. 2, the dielectric layer 32 includes the portions, each of which is interposed between a corresponding adjacent pair of the first and second control-electrode layer sections 21 and 22. Specifically, as described above, the dielectric layer 32 is at least partially disposed in the third regions RG3, each of which is defined between a corresponding adjacent pair of the first and second control-electrode layer sections 21 and 22 in the X direction.

The above configuration of each first assembly ST1 results in, during application of the control voltage, i.e., the DC voltage, across the first and second control-electrode layer sections 21 and 22 of the corresponding first assembly ST1, a first electromagnetic vector, which is substantially parallel to the X direction, being generated in the corresponding third region RG3.

The first extraction-electrode layer 11 and the second extraction-electrode layer 12 are, as illustrated in FIG. 2, arranged to face one another through the dielectric layer 32 in the Z direction.

This arrangement of the first and second extraction-electrode layer 11 and 12 results in, during application of an AC voltage across the first and second extraction-electrode layers 11 and 12, a second electromagnetic vector being generated in each third region RG3; the second electromagnetic vector intersecting with the first electromagnetic vector that is generated during application of the control voltage across the first and second control-electrode layer sections 21 and 22 of the corresponding first assembly ST1.

In particular, the second electromagnetic vector generated in each third region RG3 during application of an AC voltage across the first and second extraction-electrode layers 11 and 12 according to the exemplary embodiment is substantially orthogonal to the first electromagnetic vector generated during application of the control voltage across the first and second control-electrode layer sections 21 and 22 of the corresponding first assembly ST1.

The direction in which the first and second extraction-electrode layers 11 and 12 face one another is different from the direction in which the first and second control-electrode layer sections 21 and 22 of each first assembly ST1 face one another. This enables a distance between the first and second extraction-electrode layers 11 and 12 to be independently set from a distance between the first and second control-electrode layer sections 21 and 22 of each first assembly ST1. This therefore enables the distance between the first and second control-electrode layer sections 21 and 22 of each first assembly ST1 to be shorter without reduction in the distance between the first and second extraction-electrode layers 11 and 12.

Accordingly, the variable capacitor 1 is configured to have a shorter distance between the first and second control-electrode layer sections 21 and 22 of each first assembly ST1 while keeping a distance between the first and second extraction-electrode layers 11 and 12, which is sufficient to withstand a voltage to be applied across the first and second extraction-electrode layers 11 and 12. This configuration therefore enables the magnitude of an electric field between the first and second control-electrode layer sections 21 and 22 of each first assembly ST1 to be greater, resulting in the magnitude of the control voltage being lower.

Similarly, the distance between the first and second extraction-electrode layers 11 and 12 is set, independently of the distance between the first and second control-electrode layer sections 21 and 22 of each first assembly ST1, to a value that achieves a target capacitance of the variable capacitor 1.

The insulation layer 31 is formed of one or more materials, and the dielectric layer 32 is formed of one or more materials, one of which is different from the one or more materials of the insulation layer 31. Specifically, the insulation layer 31 is formed of an oxide film made of, for example, aluminum oxide or silicon dioxide. The oxide film of the insulation layer 31 serves to reduce damage to the insulation layer 31 during a cleaning process that uses organic matter, the process being performed before or after the formation of the first and second control electrode layers 21 and 22 of each first assembly ST1. In particular, the oxide film of the insulation layer 31 is formed of silicon dioxide. The insulation layer 31 is additionally mounted on a conductive silicon substrate.

The dielectric layer 32 includes, for example, ferroelectric polymers, such as PVDF (polyvinylidene fluoride) and P(VDF-TrFE) (poly(vinylidene fluoride-trifluoroethylene)), which are fluororesins.

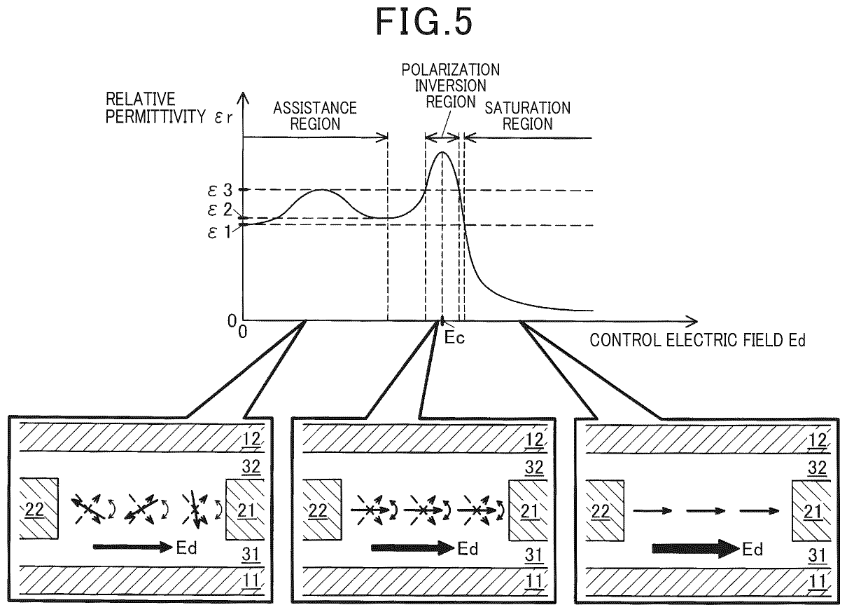

As illustrated in FIG. 4, a PVDF molecule has hydrogen atoms and fluorine atoms bonded to a carbon backbone. Because the hydrogen atoms are positively charged and the fluorine atoms are negatively charged, the PVDF molecule has electric dipole moments. When PVDF molecules aggregate via intermolecular forces, their carbon backbones tend to align in the same direction. The hydrogen and fluorine atoms are positioned in a direction perpendicular to the extension direction of the carbon backbone. Accordingly, PVDF crystals exhibit spontaneous polarization. When an electric field is applied to the PVDF crystal, the direction of polarization rotates about the X-axis that is set to the extending direction of the carbon backbone. Therefore, even when the control voltage is being applied across the first and second control-electrode layer sections 21 and 22 of each first assembly ST1, the polarization direction can change in response to an AC voltage applied across the first and second extraction-electrode layers 11 and 12. Using PVDF in the dielectric layer 32 enables the variable capacitor 1, which exhibits a large change in a relative permittivity εr of the variable capacitor 1 when the control voltage is varied, to be provided.

FIG. 5 is a graph illustrating a relationship between (i) the magnitude of a control electric field generated by the control voltage applied between the first and second control-electrode layer sections 21 and 22 and (ii) the relative permittivity εr of the variable capacitor 1 when an AC voltage is applied between the first and second extraction-electrode layers 11 and 12. The variable capacitor 1 has a dielectric characteristic in which the relative permittivity εr has two peaks.

The ferroelectric polymer exhibits spontaneous polarization when the control electric field is 0 V/m. An increase in the control electric field up to a coercive electric field Ec causes polarization to become zero, resulting in the relative permittivity εr becoming maximum. When the control electric field is in a range including the coercive electric field Ec, the electric dipole moments become highly responsive to changes in the applied AC electrical field. This results in the relative permittivity Er being likely to increase.

When the control electric field Ed becomes higher than the coercive electric field Ec, the elative permittivity εr becomes lower. This is probably because the electric dipoles are bound by the control electric field Ed so as to be unlikely to move in accordance with the applied AC voltage field.

The direction of the control electric field Ed and the direction of the AC electric field, i.e., the electrical field based on the applied AC voltage, intersect with one another. This results in, during a range of the control electric field Ed lower than the coercive electric field Ec, a peak of the relative permittivity εr appearing due to the applied AC electric field. This is probably because, under the application of the control electric field Ed, the electric dipoles become more movable when the AC voltage is further applied, as compared with the case without the application of the AC voltage.

The dielectric characteristic of the variable capacitor 1 includes an assistance region, a polarization inversion region, and a saturation region.

When a value of the control voltage Ed corresponding to the assistance region is applied across the first and second control-electrode layer sections 21 and 22, the control voltage Ed serves to assist variation of the polarization in the dielectric layer 32. Specifically, the assistance region of the dielectric characteristic of the variable capacitor 1 is defined such that (i) the control electric field Ed is lower than the coercive electric field Ec and (ii) the relative permittivity εr is higher than a first relative-permittivity threshold ε1 and lower than a second relative-permittivity threshold ε2. The first relative-permittivity threshold ε1 is a value of the relative permittivity εr when the control voltage Ed is zero. The second relative-permittivity threshold ε2 represents a local minimum of the relative permittivity εr between the two peaks.

When a value of the control voltage Ed corresponding to the polarization inversion region that includes a voltage in the coercive electric field Ec is applied across the first and second control-electrode layer sections 21 and 22, the control voltage Ed causes the electric dipoles to become more movable as compared with application of the value of the control voltage corresponding to the assist region across the first and second control-electrode layer sections 21 and 22. Specifically, the polarization inversion region of the dielectric characteristic of the variable capacitor 1 is defined such that (i) the control electric field Ed is within an electric field that includes the coercive electric field Ec and (ii) the relative permittivity εr is higher than a peak ε3 of the relative-permittivity εr in the assistance region.

When a value of the control voltage Ed corresponding to the saturation region is applied across the first and second control-electrode layer sections 21 and 22, the control voltage Ed causes the electric dipoles to be unlikely to move. Specifically, the saturation region of the dielectric characteristic of the variable capacitor 1 is defined such that (i) the control electric field Ed is higher than the coercive electric field Ec and (ii) the relative permittivity εr is lower than the first relative-permittivity threshold 21 that is shown in FIG. 5.

Application of a value of the control voltage Ed corresponding to the assistance region across the first and second control-electrode layer sections 21 and 22 of the variable capacitor 1 causes the electric dipoles to become movable as compared with no application of the control voltage Ed across the first and second control-electrode layer sections 21 and 22. That is, application of a value of the control voltage Ed corresponding to the assistance region across the first and second control-electrode layer sections 21 and 22 of the variable capacitor 1 enables the capacitance of the variable capacitor 1 to be higher as compared with no application of the control voltage Ed across the first and second control-electrode layer sections 21 and 22 of the variable capacitor 1.

When a value of the control voltage Ed corresponding to the polarization inversion region is applied across the first and second control-electrode layer sections 21 and 22, the control voltage Ed causes the electric dipoles to become more movable as compared with application of the value of the control voltage corresponding to the assist region across the first and second control-electrode layer sections 21 and 22. That is, application of a value of the control voltage Ed corresponding to the polarization inversion region across the first and second control-electrode layer sections 21 and 22 of the variable capacitor 1 enables the capacitance of the variable capacitor 1 to be higher as compared with application of a value of the control voltage Ed corresponding to the assistance region across the first and second control-electrode layer sections 21 and 22 of the variable capacitor 1.

When a value of the control voltage Ed corresponding to the saturation region is applied across the first and second control-electrode layer sections 21 and 22, the control voltage Ed causes the electric dipoles to be unlikely to move. That is, application of a value of the control voltage Ed corresponding to the saturation region across the first and second control-electrode layer sections 21 and 22 of the variable capacitor 1 enables the capacitance of the variable capacitor 1 to be lower as compared with no application of a value of the control voltage Ed corresponding to the assistance region across the first and second control-electrode layer sections 21 and 22 of the variable capacitor 1.

As described above, adjusting the magnitude of the control electric field Ed to be applied across the first and second control-electrode layer sections 21 and 22 of the variable capacitor 1 enables the capacitance of the variable capacitor 1 to be set to a desired target value.

A PVDF molecule rotates about the extending direction of the carbon backbone. For this reason, application of the AC voltage to the variable capacitor 1 in a direction that differs from the direction of the applied control voltage Ed enables the electric dipoles to be likely to move.

The dielectric layer 32 exhibits variation in its relative permittivity εr depending on the magnitude of the control electric field Ed, thereby enabling the variable capacitor 1 to achieve a high rate of capacitance variability.

Herein, the rate of capacitance variability can be expressed as the amount of change in relative permittivity εr with respect to a change in an applied electric field.

The inventors of the present disclosure considered a relationship between an interelectrode distance Dd between the first and second control-electrode layer sections 21 and 22 and a thickness Td of the dielectric layer 32. Specifically, the inventors simulated a variable range of the capacitance of the variable capacitor 1 while (i) fixing the thickness of each extraction-electrode layer 10, the thickness of the insulation layer 31, the thickness of each control-electrode layer 20, and the interelectrode distance Dd and (ii) changing the thickness Td of the dielectric layer 32 from 300 nm to 1 μm. In particular, the interelectrode distance Dd is fixed to 1 μm.

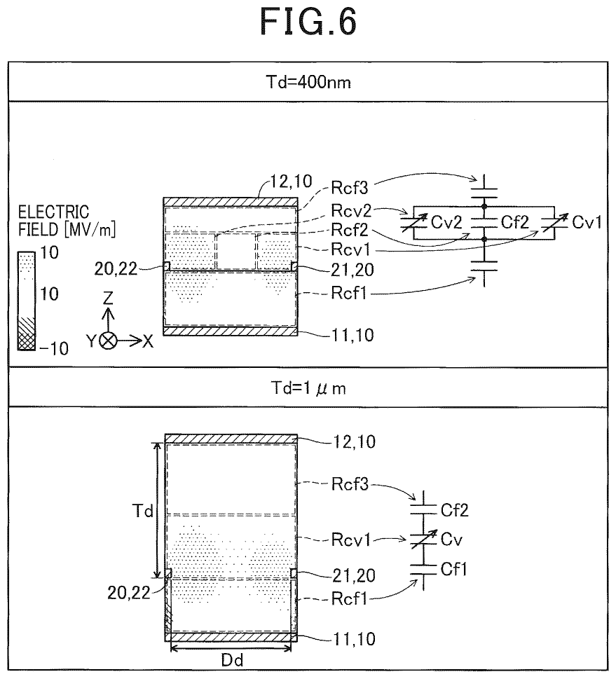

As illustrated in FIG. 6, when the thickness Td of the dielectric layer 32 is set to 1 μm (see “Td=1 μm”), the control voltage Ed is applied to the entire range from the first control-electrode layer section 21 to the second control-electrode layer section 22 in the X direction. In this case, a first fixed capacitance Cf1, a variable capacitance Cv, and a second fixed capacitance Cf2 are formed in this order from bottom to top from the bottom, i.e., the first extraction-electrode layer 11, to the top, i.e., the second extraction-electrode layer 12. An equivalent capacity Cs of the first fixed capacitance Cf1, variable capacitance Cv, and second fixed capacitance Cf2 can be expressed by the following formula (1):

$$Cs = 1 / ( 1 / Cf 1 + 1 / Cv + 1 / Cf 2 ) \qquad ( 1 )$$

where:
Cf1 represents a value of the first fixed capacitance Cf1;
Cv represents a value of the variable capacitance Cv; and
Cf2 represents a value of the second fixed capacitance Cf2.

The above formula shows that, the higher the value (1/Cv+1/Cf2) is relative to the value (1/Cf1), the more strongly the rate of change in the variable capacitance Cv tends to be reflected in the rate of change in the equivalent capacitance Cs. This is preferable because the higher the rate of change in the equivalent capacitance Cs, the higher the rate of capacitance variability of the variable capacitor 1.

The higher the value of the first fixed capacitance Cf1 is relative to the value of the variable capacitance Cv, the higher the value (1/Cv+1/Cf2) is relative to the value (1/Cf1). The first fixed capacitance Cf1 is formed in the insulation layer 31, and the variable capacitance Cv and the second fixed layer 32 are formed in the dielectric layer 32. Accordingly, using, as a material of the insulation layer 31, a material with a high relative permittivity εr enables the value of the first fixed capacitance Cf1 to be higher than the value of the variable capacitance Cv. Alternatively, reducing the thickness of the insulation layer 31 enables the value of the first fixed capacitance Cf1 to be higher relative to the value of the variable capacitance Cv.

Additionally, as illustrated in FIG. 6, when the thickness Td of the dielectric layer 32 is set to 400 nm (see “Td=400 nm”), because the thickness Td is thinner relative to the interelectrode distance Dd, the distance between the second extraction-electrode layer 12 and each control-electrode layer section 20 becomes shorter. For this reason, an electric field is generated between the second extraction-electrode layer 12 and each control-electrode layer section 20, so that the control electric field Ed is not sufficiently applied to the central portion of the region of the dielectric layer 32; the region is located between the first and second control-electrode layer sections 21 and 22 in the X direction.

For this reason, a first variable capacitance Cv1, the second fixed capacitance Cf2, and a second variable capacitance Cv2 are formed in the region of the dielectric layer 32 located between the first and second control-electrode layer sections 21 and 22 in the X direction.

Specifically, the first variable capacitance Cv1 is formed in a first subregion Rcv1 included in the region and located closer to the first control-electrode layer section 21. The second variable capacitance Cv2 is formed in a second subregion Rcv2 included in the region and located closer to the second control-electrode layer section 22. The second fixed capacitance Cf2 is formed in a third subregion Rcf2 included in the region and located between the first and second subregions Rcv1 and Rcv2. The second fixed capacitance Cf2 formed between the first and second subregions Rcv1 and Rcv2 results in the rate of capacitance variability of the variable capacitor 1 decreasing.

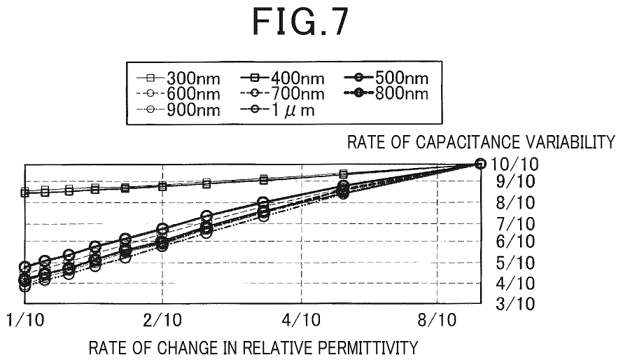

FIG. 7 shows that, when the thickness Td of the dielectric layer 32 is greater than or equal to 500 nm, the rate of capacitance variability of the variable capacitor 1 becomes high.

The horizontal axis of FIG. 7 indicates the rate of change in the relative permittivity εr of the dielectric layer 32. Specifically, the horizontal axis of FIG. 7 represents the rate of change in the relative permittivity εr relative to a predetermined reference value of 10 of the relative permittivity εr; the reference value of 10 of the relative permittivity εr corresponds to a measured value of the relative permittivity εr under a condition that the control electric field Ed is 0 V/m. For example, 1/10 indicates that a value of the relative permittivity εr is one-tenth of the reference value of the relative permittivity εr.

The vertical axis of FIG. 7 indicates the rate of change in the capacitance of the variable capacitor 1, i.e., the equivalent capacitance Cs of the variable capacitor 1. Specifically, like the horizontal axis, the vertical axis of FIG. 7 represents the rate of change in the equivalent capacitance Cs relative to a predetermined reference value of 10 of the equivalent capacitance Cs; the reference value of 10 of the equivalent capacitance Cs corresponds to a measured value of the equivalent capacitance Cs under a condition that the control electric field Ed is 0 V/m.

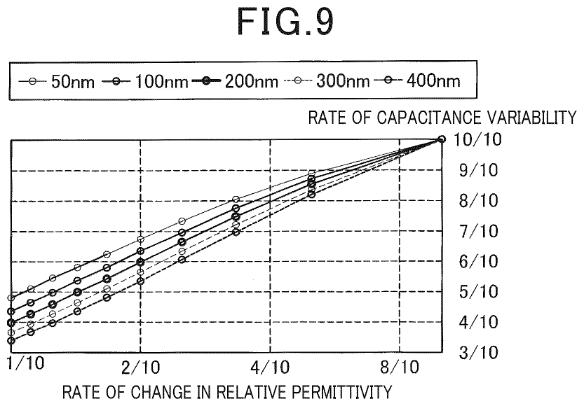

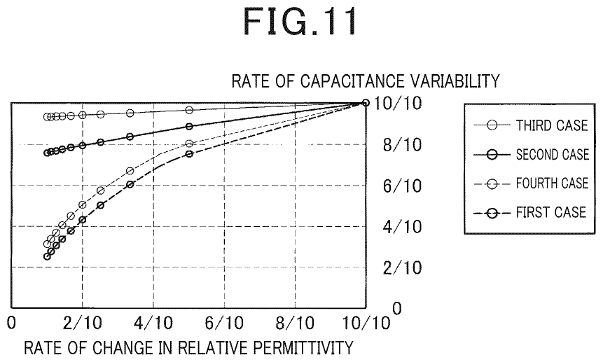

The greater the gradient of each characteristic line illustrated in FIG. 7, is, the rate of change in the capacitance of the variable capacitor 1 relative to the control electric field Ed, i.e., the rate of capacitance variability of the variable capacitor 1, is. This can be similarly applied to each of FIGS. 9 and 11 described later.

That is, in cases where the thickness Td of the dielectric layer 32 is greater than or equal to 500 nm, the value of the variable capacitance Cv of the variable capacitor 1 increases as the thickness Td increases, resulting in the rate of capacitance variability of the variable capacitor 1 increasing. For this reason, it is preferable that the dielectric layer 32 of the variable capacitor 1 has a sufficient thickness.

The above descriptions lead to the conclusion that the variable capacitor 1 has a sufficiently high rate of capacitance variability as long as the interelectrode distance Dd and the thickness Td of the dielectric layer 32 satisfy the following formula (2):

$$T d \geq Dd / 2 \qquad ( 2 )$$

The inventors of the present disclosure considered a thickness Te of each control-electrode layer section 20. Specifically, the inventors simulated an electric-field distribution in a space formed between the first and second extraction-electrode layers 11 and 12 while (i) fixing the thickness of each of the first extraction-electrode layer 11, the dielectric layer 31, and the dielectric layer 32 and (ii) changing the thickness Te of each control-electrode layer section 20. In particular, the thickness Td of the dielectric layer 32 is fixed to 500 nm.

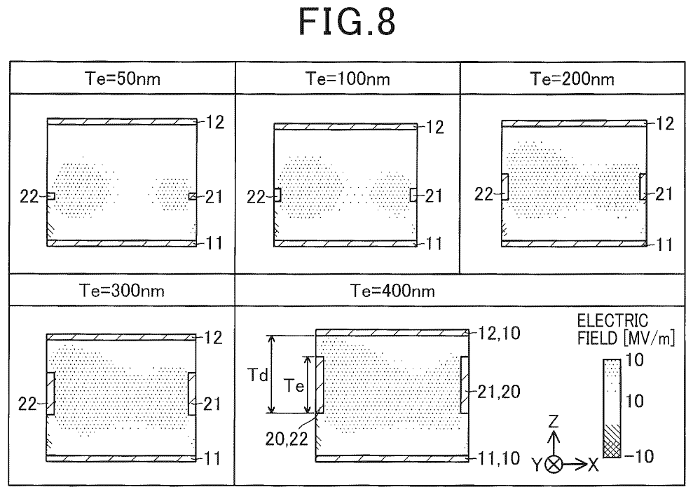

FIG. 8 illustrates the simulation results showing that increasing the thickness Te of each control-electrode layer section 20 causes the electric field to reach closer to the center of the space formed between the first and second extraction-electrode layers 11 and 12. In particular, FIG. 9 shows that, when the thickness Te of each control-electrode layer section 20 is greater than or equal to 50 nm, the rate of capacitance variability of the variable capacitor 1 becomes high.

The above descriptions lead to the conclusion that the variable capacitor 1 has a sufficiently high rate of capacitance variability as long as the thickness Te of each control-electrode layer section 20 and the thickness Td of the dielectric layer 32 satisfy the following formula (3):

$$T e \geq Td / 10 \qquad ( 3 )$$

The inventors of the present disclosure considered a relationship between the control voltage and an extraction voltage applied between the first and second extraction-electrode layers 11 and 12.

Specifically, the inventors examined how an electric-field distribution changed while selecting, as each of the control voltage and the extraction voltage, one of (i) a positive voltage between a positive power supply and a ground (ii) a voltage between negative and positive power supplies.

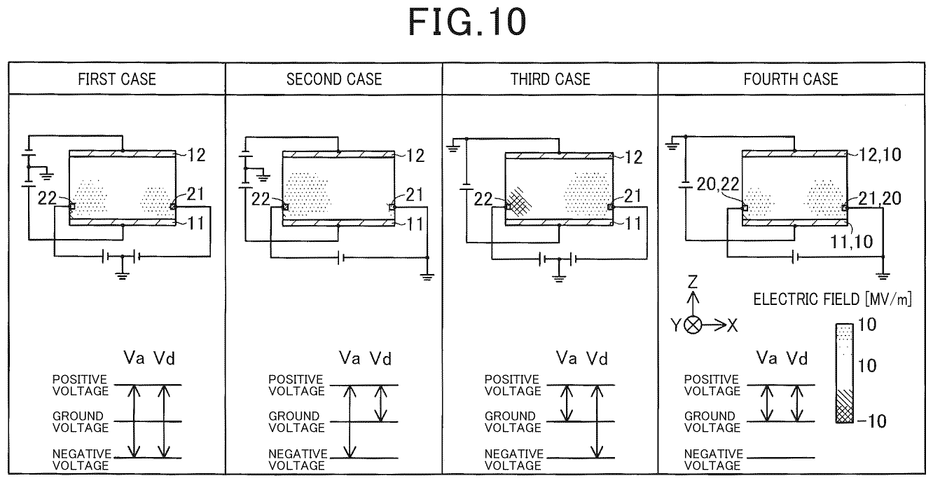

In FIG. 10, reference character Vd represents the control voltage, and reference character Va represents the extraction voltage. Setting the range of the control voltage Vd to be identical to that of the extraction voltage Va enables, as illustrated in FIG. 10, the electric field to be applied throughout from the first control-electrode layer section 21 to the second control-electrode layer section 22 inclusive in the X direction. This results in the rate of capacitance variability of the variable capacitor 1 increasing.

Specifically, an example (see the first case in FIG. 10) of setting the range of the control voltage Vd to be identical to that of the extraction voltage Va is that a voltage across a first pair of negative and positive power supplies is applied between the electrode layer sections 21 and 22 and a voltage across a second pair of negative and positive power supplies is applied between the electrode layers 11 and 12. Additionally, another example (see the fourth case in FIG. 10) of setting the range of the control voltage Vd to be identical to that of the extraction voltage Va is that a voltage across the corresponding positive power supply and a corresponding ground is applied between the electrode layer sections 21 and 22 and a voltage across the corresponding positive power supply and a corresponding ground is applied between the electrode layers 11 and 12.

FIG. 11 shows that each of the first and fourth cases achieves a higher rate of capacitance variability of the variable capacitor 1 as compared with the other cases, such as the second and third cases illustrated in FIG. 10. Accordingly, setting the range of the control voltage Vd to be identical to that of the extraction voltage Va (see the first case or the fourth case) enables the variable capacitor 1 to have a higher rate of capacitance variability. In particular, setting the range of the control voltage Vd to be identical to that of the extraction voltage Va in accordance with the fourth case is preferable because the variable capacitor 1 has no need of negative power supplies and therefore has a simpler configuration.

The variable capacitor 1 of the exemplary embodiment described above includes the first extraction-electrode layer 11, the first control-electrode layer sections 21, the dielectric layer 32, and the second control-electrode layer sections 22; the first control-electrode layer sections 21, the dielectric layer 32, and the second control-electrode layer sections 22 are disposed on the insulation layer 31. The variable capacitor 1 of the exemplary embodiment described above additionally includes the second extraction-electrode layer 12 disposed on the dielectric layer 32.

The first and second control-electrode layer sections 21 and 22 of each first assembly ST1 are arranged to face one another in a direction along the dielectric layer 31, and the first and second extraction-electrode layers 11 and 12 are arranged to face one another in the stacking direction of the layers of the variable capacitor 1.

The variable capacitor 1 is configured such that a direction of a first electric field applied to the dielectric layer 32 based on application of the control voltage Vd across the first and second control-electrode layer sections 21 and 22 of each first assembly ST1 is different from that of a second electric field applied to the dielectric layer 32 based on application of a voltage across the first and second first and second extraction-electrode layers 11 and 12. The first and second control-electrode layer sections 21 and 22 of each first assembly ST1 has a shorter distance therebetween enables the control voltage Vd to be lower. The insulation layer 32 is arranged to isolate the control-electrode layer sections 20 from the first extraction-electrode layer 11.

The insulation layer 31 is formed of an oxide film that has resistance to chemicals used in the process of forming the upper layers of the insulation layer 31, making it possible to improve the manufacturability of the variable capacitor 1.

The interelectrode distance Dd between the first and second control-electrode layer sections 21 and 22 of each first assembly ST1 in the X direction defined as a first direction and the thickness Td of the dielectric layer 32 satisfy the formula (2) set forth above. This results in the variable capacitor 1 having a higher rate of capacitance variability.

The thickness Te of each of the first and second control-electrode layer sections 21 and 22 and the thickness Td of the dielectric layer 32 satisfy the formula (3) set forth above. This results in the variable capacitor 1 having a higher rate of capacitance variability.

The variable capacitor 1 is configured such that
(I) A negative power-supply voltage is applied to each first control-electrode layer section 21,
(II) A positive power-supply voltage is applied to each second control-electrode layer section 22,
(III) A negative power-supply voltage is applied to the first extraction-electrode layer 11, and
(IV) A positive power-supply voltage is applied to the second extraction-electrode layer 12

This configuration results in the variable capacitor 1 having a higher rate of capacitance variability.

The variable capacitor 1 is configured such that
(I) Each first control-electrode layer section 21 is grounded
(II) A positive power-supply voltage is applied to each second control-electrode layer section 22,
(III) The first extraction-electrode layer 11 is grounded, and
(IV) A positive power-supply voltage is applied to the second extraction-electrode layer 12

This configuration results in the variable capacitor 1 having a higher rate of capacitance variability.

### MODIFICATIONS

The insulation layer 31 of the exemplary embodiment includes an oxide film, but may include a dielectric having a relative permittivity of 10 or more. As a dielectric having a relative permittivity of 10 or more, materials such as PVDF or inorganic high-permittivity materials such as barium titanate can be used. A great difference between the relative permittivity of the insulation layer 31 and that of the dielectric layer 32 may prevent movement of electric dipoles at the boundary between the insulation layer 31 and dielectric layer 32. For this reason, using the insulation layer 31 having a sufficiently high relative permittivity enables the electric poles to be likely to move, making it possible to improve the rate of capacitance variability of the variable capacitor 1. Using a general-purpose high dielectric film as the insulation layer 31 enables the variable capacitor 1 to have a higher manufacturability.

The insulation layer 31 of the exemplary embodiment includes an oxide film, but may include ferroelectric polymers. Using the insulation layer 31 formed of ferroelectric polymers enables the relative permittivity Er of the variable capacitor 1 to be variable during application of the control voltage across the first and second control-electrode layer sections 21 and 22. This therefore results in the variable capacitor 1 having a higher rate of capacitance variability.

The variable capacitor 1 of the exemplary embodiment, which is formed on a conductive silicon substrate, may be formed on a silicon dioxide layer, an aluminum oxide layer, or an aluminum electrode layer, which is formed on a silicon substrate.

The present disclosure is not limited to the above exemplary embodiment and its modifications, and can be implemented by various configurations within the scope of the present disclosure. For example, technical features included in the exemplary embodiment and its modifications, which correspond to technical features included in the exemplary aspect described in the SUMMARY of the present disclosure, can be freely combined with each other or can be freely replaced with another feature in order to solve a part or all of the above issue and/or achieve a part or all of the above advantageous benefits. One or more of the technical features included in the above exemplary embodiment and its modifications, which are not described as essential elements in the specification, can be omitted as necessity arises.

The following describes technological aspects of the present disclosure.

### First Technological Aspect

A variable capacitor (1) according to the first technological aspect includes a first electrode layer (11), an insulation layer (31) disposed on the first electrode layer, and at least one second electrode layer section (21) arranged in at least one first region (RG1) that is defined on the insulation layer. The variable capacitor includes at least one third electrode layer section (22) arranged in at least one second region (RG2) that is defined on the insulation layer. The at least one second region is disposed apart from the at least one first region. The variable capacitor includes a dielectric layer (32) at least partially arranged in at least one third region (RG3) disposed on the insulation layer and interposed between the at least one first region and the at least one second region.

The variable capacitor includes a fourth electrode layer (12) disposed on the dielectric layer.

### Second Technological Aspect

In the variable capacitor of the second technological aspect, which depends from the first technological aspect, the insulation layer includes an oxide film.

### Third Technological Aspect

In the variable capacitor of the third technological aspect, which depends from the first or second technological aspect, the at least one second electrode layer section and the at least one third electrode layer section are electrode layer sections across which a control voltage is to be applied for changing a relative permittivity of the insulation layer. Each of the first and fourth electrode layers is an electrode layer from which a capacitance of the variable capacitor is to be extracted. The dielectric layer is arranged to cover the at least one second electrode layer section and the at least one third electrode layer section. The dielectric layer has a thickness. An interelectrode distance between the at least one second electrode layer section and the at least one third electrode layer section in a first direction that is along an in-plane direction of the insulation layer and the thickness of the dielectric layer satisfy the following formula (I):

$$T d \geq Dd / 2 \qquad ( I )$$

where:
Td represents the thickness of the dielectric layer; and
Dd represents the interelectrode distance.

### Fourth Technological Aspect

In the variable capacitor of the fourth technological aspect, which depends from any one of the first to third technological aspects, the dielectric layer is arranged to cover the at least one second electrode layer section and the at least one third electrode layer section. The at least one second electrode layer section and the at least one third electrode layer section substantially have the same thickness. The dielectric layer has a thickness. The thickness of the at least one second electrode layer section and the thickness of the dielectric layer satisfy the following formula (II):

$$T e \geq Td / 10 \qquad ( II )$$

where:
Te represents the thickness of the at least one second electrode layer section; and
Td represents the thickness of the dielectric layer.

### Fifth Technological Aspect

In the variable capacitor of the fifth technological aspect, which depends from any one of the first to fourth technological aspects, the variable capacitor is configured such that
(i) A first negative power-supply voltage is applied to one of the at least one second electrode layer section and the at least one third electrode layer section,
(ii) A first positive power-supply is applied to the other of the at least one second electrode layer section and the at least one third electrode layer section,
(iii) A second negative power-supply voltage is applied to one of the first electrode layer and the fourth electrode layer, and
(iv) A second positive power-supply voltage is applied to the other of the first electrode layer and the fourth electrode layer.

### Sixth Technological Aspect

In the variable capacitor of the sixth technological aspect, which depends from any one of the first to fifth technological aspects, one of the at least one second electrode layer section and the at least one third electrode layer section is grounded. One of the first electrode layer and the fourth electrode layer is grounded. The variable capacitor is configured such that (i) A first positive power-supply is applied to the other of the at least one second electrode layer section and the at least one third electrode layer section, and (ii) A first positive power-supply voltage is applied to the other of the first electrode layer and the fourth electrode layer.

### Seventh Technological Aspect

In the variable capacitor of the seventh technological aspect, which depends from any one of the first to sixth technological aspects, the insulation layer includes a dielectric having a relative permittivity of 10 or more.

### Eighth Technological Aspect

In the variable capacitor of the eighth technological aspect, which depends from any one of the first to seventh technological aspects, the insulation layer includes one or more ferroelectric polymers.

### Ninth Technological Aspect

In the variable capacitor of the ninth technological aspect, which depends from any one of the first to eighth technological aspects, the at least one second electrode layer section includes a plurality of second electrode layer sections, and the at least one third electrode layer section includes a plurality of third electrode layer sections. The second electrode layer sections have a comb-like shape, and the third electrode layer sections have a comb-like shape. The second and third electrode layer sections are alternately arranged in a first direction that is along an in-plane direction of the insulation layer.

1. A variable capacitor comprising:
a first electrode layer;
an insulation layer disposed on the first electrode layer;
at least one second electrode layer section arranged in at least one first region that is defined on the insulation layer;
at least one third electrode layer section arranged in at least one second region that is defined on the insulation layer, the at least one second region being disposed apart from the at least one first region;
a dielectric layer at least partially arranged in at least one third region disposed on the insulation layer and interposed between the at least one first region and the at least one second region; and
a fourth electrode layer disposed on the dielectric layer.

2. The variable capacitor according to claim 1, wherein:
the insulation layer includes an oxide film.

3. The variable capacitor according to claim 1, wherein:
the at least one second electrode layer section and the at least one third electrode layer section are electrode layer sections across which a control voltage is to be applied for changing a relative permittivity of the insulation layer;
each of the first and fourth electrode layers is an electrode layer from which a capacitance of the variable capacitor is to be extracted;
the dielectric layer is arranged to cover the at least one second electrode layer section and the at least one third electrode layer section;
the dielectric layer has a thickness; and
an interelectrode distance between the at least one second electrode layer section and the at least one third electrode layer section in a first direction that is along an in-plane direction of the insulation layer and the thickness of the dielectric layer satisfy the following formula (I):
$$T d \geq Dd / 2 \qquad ( I )$$
where:
Td represents the thickness of the dielectric layer; and
Dd represents the interelectrode distance.

4. The variable capacitor according to claim 1, wherein:
the dielectric layer is arranged to cover the at least one second electrode layer section and the at least one third electrode layer section;
the at least one second electrode layer section and the at least one third electrode layer section substantially have the same thickness;
the dielectric layer has a thickness; and
the thickness of the at least one second electrode layer section and the thickness of the dielectric layer satisfy the following formula (II):
$$T e \geq Td / 10 \qquad ( II )$$
where:
Te represents the thickness of the at least one second electrode layer section; and
Td represents the thickness of the dielectric layer.

5. The variable capacitor according to claim 1, wherein:
the variable capacitor is configured such that:
a first negative power-supply voltage is applied to one of the at least one second electrode layer section and the at least one third electrode layer section;
a first positive power-supply is applied to the other of the at least one second electrode layer section and the at least one third electrode layer section;
a second negative power-supply voltage is applied to one of the first electrode layer and the fourth electrode layer; and
a second positive power-supply voltage is applied to the other of the first electrode layer and the fourth electrode layer.

6. The variable capacitor according to claim 1, wherein:
one of the at least one second electrode layer section and the at least one third electrode layer section is grounded;
one of the first electrode layer and the fourth electrode layer is grounded; and
the variable capacitor is configured such that:
a first positive power-supply is applied to the other of the at least one second electrode layer section and the at least one third electrode layer section; and
a first positive power-supply voltage is applied to the other of the first electrode layer and the fourth electrode layer.

7. The variable capacitor according to claim 1, wherein:
the insulation layer includes a dielectric having a relative permittivity of 10 or more.

8. The variable capacitor according to claim 1, wherein:
the insulation layer includes one or more ferroelectric polymers.

9. The variable capacitor according to claim 1, wherein:
the at least one second electrode layer section comprises a plurality of first electrode-layer sections;
the at least one third electrode layer section comprises a plurality of second electrode layer sections;
the second electrode layer sections have a comb-like shape;
the third electrode layer sections have a comb-like shape; and
the second and third electrode layer sections and are alternately arranged in a first direction that is along an in-plane direction of the insulation layer.
